(19) United States
(12) Patent Application Publication
(10) Pub. No.: US 2010/0084825 A1
(43) Pub. Date: Apr. 8, 2010

(54) TEXTILE GASKET AND METHOD OF CONSTRUCTION THEREOF

(76) Inventors: Cassie Malloy, Bluebell, PA (US); Zhong Huai Zhang, Pottstown, PA (US); Ming-Ming Chen, West Chester, PA (US); Lucia Della Putta, Venette (FR); Gerard Mirmand, Roissy en Brie (FR); Linwood Ludy, Pottstown, PA (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/539,974

(22) Filed: Aug. 12, 2009

Related U.S. Application Data
(60) Provisional application No. 61/088,441, filed on Aug. 13, 2008.

(51) Int. Cl. F16L 21/025; D04B 1/22

(52) U.S. Cl. 277/604; 66/170

(57) ABSTRACT

A textile gasket and method of construction thereof for establishing a seal between mating members in a high temperature application is provided. The gasket has a knit, tubular body constructed at least in part of non-metallic, heat-resistant yarns. The body extends between opposite ends with at least one of the ends being rolled toward the other end to form a circumferentially extending rolled portion of a predetermined diameter for receipt between the mating members.

CROSS-REFERENCE TO RELATED APPLICATION

This application claims the benefit of U.S. Provisional Application Ser. No. 61/088,441, filed Aug. 13, 2008, which is incorporated herein by reference in its entirety.

### BACKGROUND OF THE INVENTION

1. Technical Field

This invention relates generally to gaskets for establishing a seal between mating members, and more particularly to heat resistant textile gaskets.

2. Related Art

It is known to create a heat resistant seal between mating members with a gasket having multiple components, such as a felt portion and a rope portion or a gasket formed by a pair of separate rope portions. Although these gaskets can provide a reliable seal, the gaskets are typically costly in manufacture, particularly given the use of multiple components to form the gaskets. In addition to increased material cost, having multiple components introduces an added source for failure. The added failure mode stems largely from the components typically being attached or bonded to one another, thereby providing a location for separation and failure in use.

Aside from the gaskets described above, it is also known to form gaskets from a knitted wire mesh. The wire mesh gaskets are compacted in a die to take on a specific shape for their intended use. In addition, heat resistant materials can be infiltrated into the wire mesh to enhance their sealing properties. Some potential problems with these gaskets include, for example, a limited tolerance for expansion in use, a limited tolerance for compression in use, and corrosion of the wire material. In addition to having a limited tolerance for expansion in use, these gaskets are also generally rigid and inflexible, making them application specific. Accordingly, their use is generally intended for specific applications, and thus, they are not able to be used across applications having different mating surface configurations. In addition, with the gasket wire material being relatively inflexible, these gaskets are generally intolerant of sealing flaws in mating surfaces, and thus, leaks ultimately occur. Further yet, with the wire gaskets being prone to corrosion, their shelf life prior to use is generally limited.

### SUMMARY OF THE INVENTION

According to one presently preferred aspect of the invention, a textile gasket for establishing a seal between mating members in a high temperature application is provided. The gasket has a knit, seamless tubular body with a plurality of non-metallic, heat-resistant yarns knit with one another using a plurality of knit stitches. The body extends between opposite ends with at least one of the ends being rolled toward the other end to form a circumferentially extending rolled portion of a predetermined diameter for receipt between the mating members.

In accordance with another aspect of the invention, both ends are rolled toward one another to form a pair of circumferentially extending rolled portions of a predetermined diameter for receipt between the mating members.

In accordance with another aspect of the invention, the pair of circumferentially extending rolled portions remain axially spaced from one another by an unrolled bridge portion of the body to provide the rolled portions as separate first and second sealing portions spaced from one another for establishing a seal between axially spaced regions of the mating members.

In accordance with another aspect of the invention, the tubular body includes a plurality of metallic yarns knit with the non-metallic yarns.

In accordance with another aspect of the invention, a first portion of the body extending inwardly from one end is formed entirely of the non-metallic yarns and a second portion of the body extending inwardly from the other end is formed entirely of the metallic yarns. The non-metallic first portion is reverse folded inwardly of the metallic second portion, and the non-metallic yarns of the first portion face radially outwardly from the body upon rolling one of the ends.

In accordance with another aspect of the invention, a method of constructing a textile gasket is provided. The method includes providing a plurality of non-metallic yarns and knitting the yarns with one another into a seamless tubular body having a length extending between opposite ends. Then, rolling at least one of the ends toward the other end to form a first circumferentially extending rolled sealing portion of a predetermined diameter for receipt between mating members to be sealed.

In accordance with another aspect of the invention, the method further includes knitting a metallic yarn with the non-metallic yarns on a knitting machine to provide the tubular body with both non-metallic yarns and metallic yarns.

In accordance with another aspect of the invention, the method includes performing the knitting on a weft knitting machine.

In accordance with another aspect of the invention, the method includes performing the knitting on a flat bed weft knitting machine.

In accordance with another aspect of the invention, the method further includes knitting the non-metallic yarns to extend inwardly from one of the ends of the tubular body and knitting the metallic yarns to extend inwardly from the other of the ends of the tubular body.

In accordance with yet another aspect of the invention, the method further includes reverse folding the non-metallic yarns inwardly of the metallic yarns and then rolling at least one of the ends to bring the non-metallic yarns into radially outwardly facing relation relative to the metallic yarns.

In accordance with another aspect of the invention, the method further includes knitting the non-metallic and metallic yarns with one another using a double jersey knit stitch.

In accordance with another aspect of the invention, the method further includes laying metallic yarns into the non-metallic yarns.

In accordance with yet another aspect of the invention, the method further includes rolling both ends toward one another to form separate first and second circumferentially extending rolled sealing portions.

In accordance with yet another aspect of the invention, the method further includes rolling both ends toward one another to form separate and axially spaced first and second circumferentially extending rolled sealing portions.

### BRIEF DESCRIPTION OF THE DRAWINGS

These and other aspects, features and advantages of the invention will become readily appreciated when considered in connection with the following detailed description of presently preferred embodiments and best mode, appended claims and accompanying drawings, in which:

FIG. 1 is a schematic cross-sectional exploded view of a pair of members arranged for sealed engagement with one another with a textile gasket constructed according to one aspect of the invention disposed therebetween;

FIG. 2 is a schematic plan view of a body of the gasket of FIG. 1 knit according to one aspect of the invention with the body shown in an unrolled, extended configuration;

FIG. 3 is a view similar to FIG. 1 with the gasket arranged in an inverted configuration;

FIG. 4 is a view similar to FIG. 3 with the gasket arranged in another configuration;

FIG. 5 is a view similar to FIG. 3 with the gasket arranged in yet another configuration;

FIG. 6 is a schematic cross-sectional view of a pair of members movable relative to one another with a textile gasket constructed according to another aspect of the invention establishing seal between the members;

FIG. 7 is a schematic cross-sectional view of a pair of members sealed with one another via a textile gasket constructed according to another aspect of the invention;

FIG. 8 is a schematic side view of a textile gasket material constructed according to another aspect of the invention with the material shown in an unrolled, extended configuration;

FIG. 9 is a view of the gasket material of FIG. 8 shown in a reverse folded configuration;

FIG. 10 is a view of the gasket material of FIG. 8 shown in a fully rolled configuration;

FIG. 11 is a schematic plan view of a body of textile gasket material constructed according to another aspect of the invention with the body shown in an unrolled, extended configuration;

FIG. 11A is a view of the gasket material of FIG. 11 shown in a rolled configuration;

FIG. 12 is a schematic side view of a body of textile gasket material constructed according to yet another aspect of the invention with the body shown in an unrolled, extended configuration; and

FIG. 12A is a view of the gasket material of FIG. 11 shown in a rolled configuration.

### DETAILED DESCRIPTION OF PRESENTLY PREFERRED EMBODIMENTS

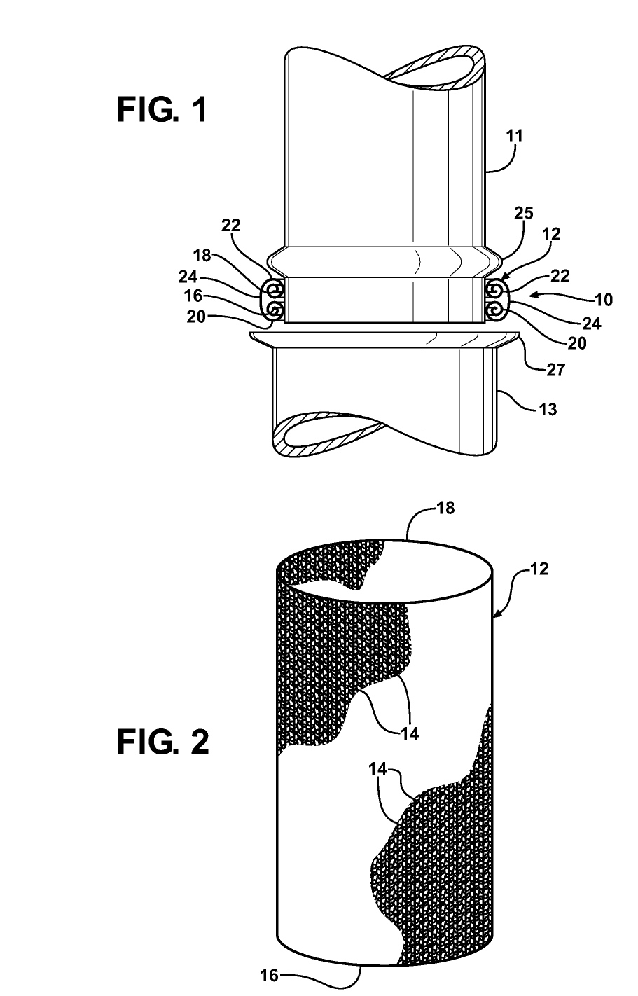

Referring in more detail to the drawings, FIG. 1 illustrates a textile gasket 10 for establishing a seal between mating members in a high temperature application, such as a pair of exhaust pipe members 11, 13, for example. The gasket 10 has a knit, seamless tubular body 12 (FIG. 2) constructed of at least one or a plurality of non-metallic, heat-resistant yarns, identified generally at 14, knit with one another with a plurality of knit stitches. The body 12 extends between opposite ends 16, 18 with at least one end preferably being lock-knit stitched and with at least one of the ends, and shown here as both ends 16, 18 being rolled toward one another and forming radially inwardly facing circumferentially extending scrolled sealing portions 20, 22 of a predetermined diameter for receipt between the pipe members 11, 13. With the body 12 being knit from non-metallic yarns, such as a high temperature resistant basalt or silica material, for example, the gasket 10 is flexible and is expandable radially during installation. Further, the scrolled sealing portions 20, 22 are relatively easy to roll in installation, and also are readily compressible to form an air-tight seal between the pipe members 11, 13. In addition, the non-metallic yarns 14 provide the gasket 10 with a long and useful life in application and in storage.

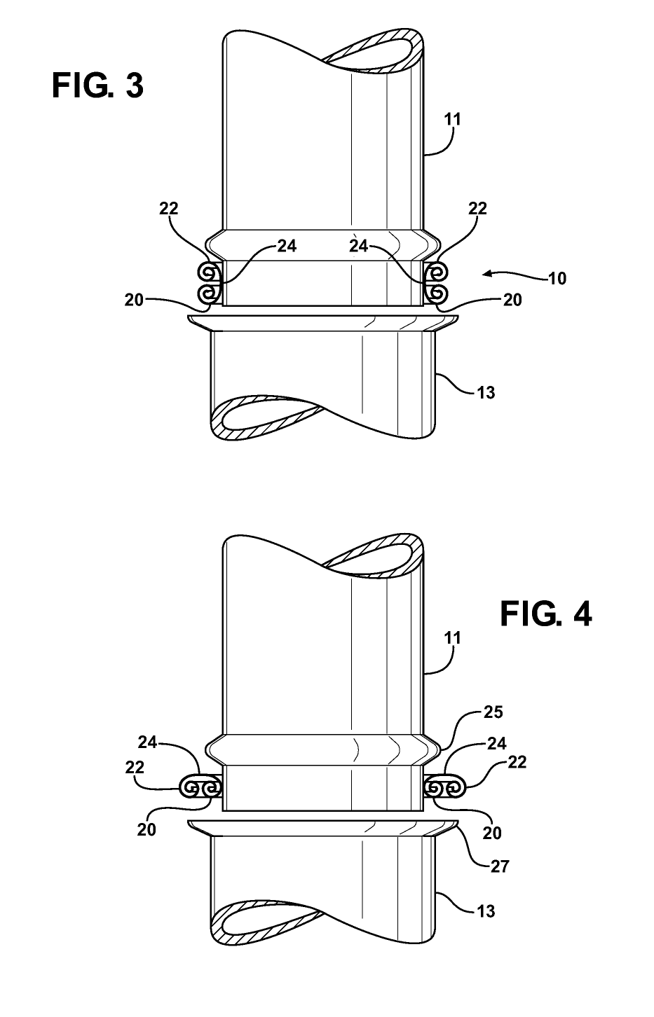

The seamless, tubular body 12 is knit in a single knitting process using a knitting machine, and preferably a weft knitting machine, and more preferably a flat bed weft knitting process or machine. However, it is contemplated that a tubular body 12 constructed in accordance with the invention could be knit on other types of knitting machines, such as a circular weft knitting machine, for example. As such, the need for any secondary operations is negated. The body 12 can be knit having any suitable diameter and length, depending on the application and on the size of the gasket 10 desired. Upon knitting the body 12 as a one-piece, monolithic member, either one or both of the ends 16, 18 are rolled toward one another to form the radially inwardly facing scrolled portions 20, 22 (FIG. 1), or radially outwardly facing scrolled portion 20, 22 (FIG. 3). As such, an unrolled bridge section 24 is formed interconnecting the opposite rolled sealing portions 20, 22. With the body 12 being formed by interlinked knit stitches, the finished gasket 10 is able to stretch radially to increase the overall diameter of the gasket 10. Upon expanding the body 12 radially, the ends 16, 18 tend to self curl, and thus, the scrolled sealing portions 20, 22 tend to remain in their desired rolled configuration.

As shown in FIG. 1, upon disposing the gasket on one pipe member 11, the other pipe member 13 can be joined to the pipe member 11 to bring the gasket 10 into a compressed sealing state between the pipe members 11, 13. Preferably, each pipe member 11, 13 has a radially extending flange 25, 27 to facilitate compressing the scrolled sealing portions 20, 22 toward one another to establish the air-tight seal.

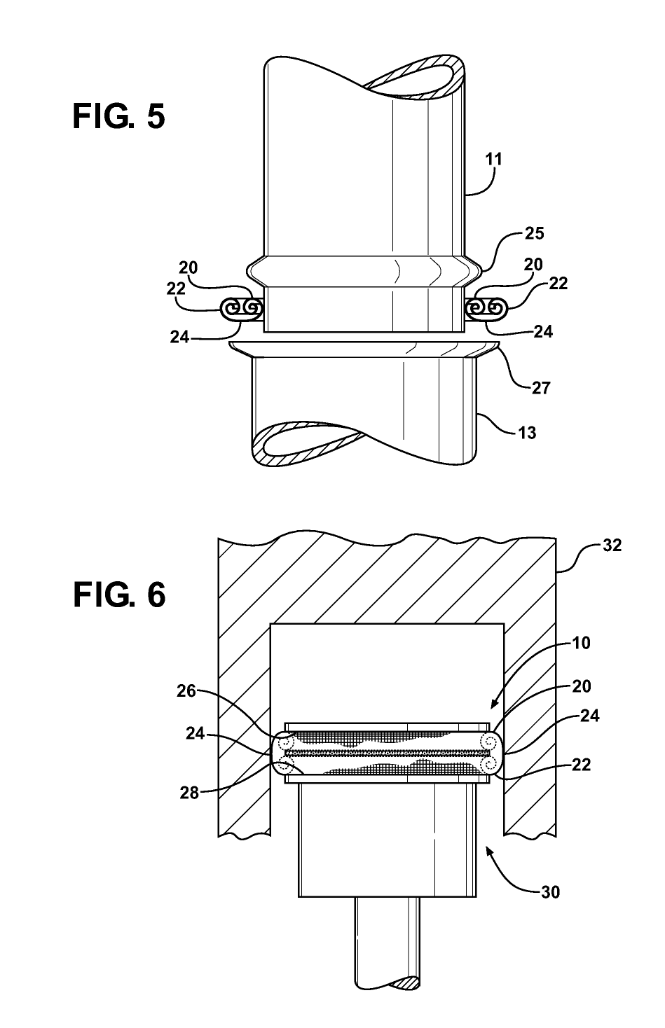

As shown in FIG. 3, the gasket 10 can be disposed on the pipe member 11 in an inverted configuration in comparison to FIG. 1. Accordingly, the bridge section 24, rather than facing radially outward, is oriented facing radially inwardly in abutment with the pipe member 11. Otherwise, as shown in FIGS. 4 and 5, the scrolled sealing portions 20, 22, rather than both being arranged to abut the outer surface of the pipe member 11 and thereby having a substantially common diameter, can be stretched so that one scrolled sealing portion 20 is radially aligned inwardly of the other scrolled sealing portion 22. As shown in FIG. 4, the bridge section 24 can be arranged to abut the flange 25 of the pipe member 11, or, as shown in FIG. 5, the bridge section 24 can be arranged to abut the flange 27 of the pipe member 13, as desired.

As shown in FIG. 6, the gasket 10 can be configured for receipt in a pair of ring grooves 26, 28 of a plunging member, such as a piston 30, for example. The bridge section 24 is oriented to face radially outwardly, and the separate scrolled sealing portions 20, 22 are sized to fit within annular grooves 26, 28 of the piston 30 and to remain therein during reciprocation of the piston 30 within a cylinder 32. It should be recognized that the bridge section 24 can span any desired distance to allow the scrolled portions 20, 22 to be received in the grooves 26, 28.

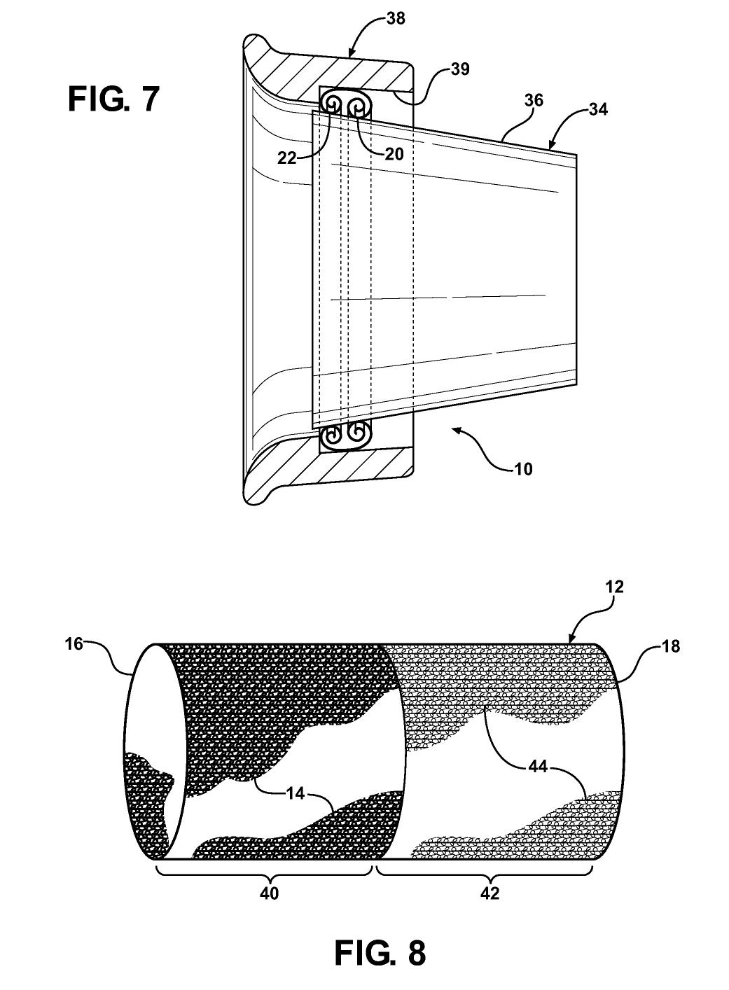

As shown in FIG. 7, the gasket 10 can be configured to establish an air-tight seal across an area having non-parallel surfaces, and thus, having a varying area to be sealed, such as a frustroconical area, for example. For example, an inner member 34 having a conical or frustroconical shape with an outer tapered surface 36 and an outer member 38 having a generally cylindrical bore 39 to be sealed with the tapered surface 36 can be sealed with one another via the gasket 10. In order to establish a reliable air-tight seal across the varying, axially extending, radial area between the non-parallel surfaces 36, 39, one scrolled sealing portion 20 of the gasket 10 can be formed having a smaller, reduced inner bore diameter and the other scrolled sealing portion 22 can be formed having a larger, increased inner bore diameter with the bridge section 24 extending therebetween. The relative sizes of the separate sealing portions 20, 22 can be established while rolling the opposite ends 16, 18 toward one another, wherein the smaller sealing portion 20 is rolled over a greater axial distance of the gasket knit material than the larger diameter sealing portion 22. Accordingly, the smaller diameter sealing portion 20 has an increased number of rolled layers as view in cross-section. It should be recognized that either scrolled sealing portion 20, 22 can be formed as large or as small as desired, depending on the configuration and size of the areas being sealed.

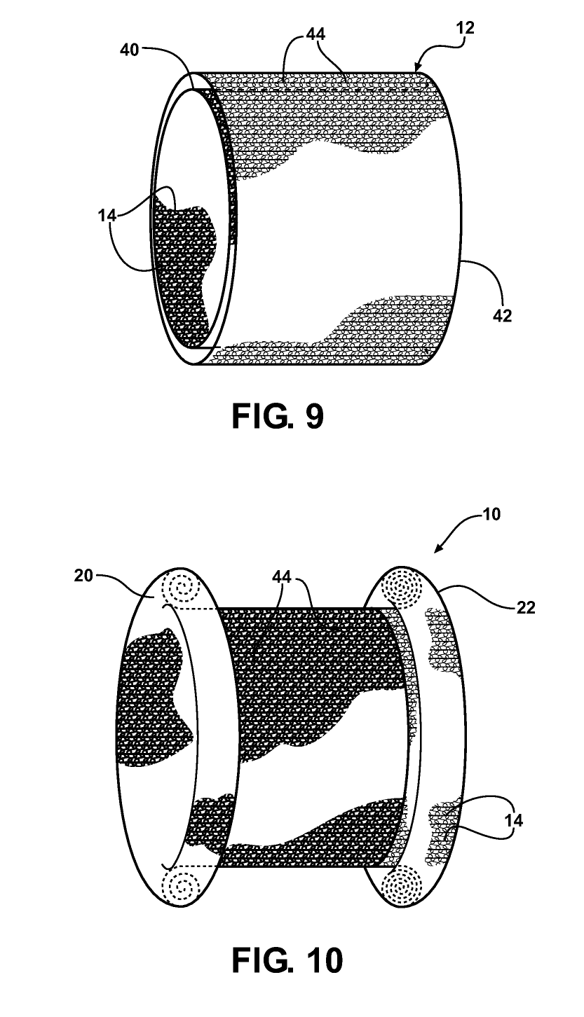

As shown in FIGS. 8 and 9, the body 12 of the gasket 10 can be knit having a first portion 40 extending axially inwardly from one of the ends 16 and a second portion 42 extending axially inwardly from the other of the ends 18, wherein the first and second portions 40, 42 are constructed differently from one another. For example, the first portion 40 can be knit entirely of the non-metallic, high temperature resistant yarns 14 and the second portion 42 can be formed entirely of metallic yarns 44, such as stainless steel yarns, by way of example and without limitation. Upon knitting the full length of the body 12 in a single knitting process, the second portion 42 can be reverse folded radially outwardly of the first portion 40, or the first portion 40 can be reverse folded radially inwardly of the second portion 42, such that the metallic yarns 44 become disposed radially outwardly of the non-metallic yarns 14. Then, as shown in FIG. 10, one or both of the ends of the reverse folded body 12 are rolled a predetermined distance to form axially opposed scrolled sealing portions 20, 22. Upon rolling the ends of the reverse folded body 12, the inner, non-metallic yarns 14 are exposed to face radially outwardly from the body 12, wherein the metallic yarns 44 become covered by the non-metallic yarns 14, thereby providing an outer surface that is suitable for establishing a reliable, air-tight seal. Meanwhile, the covered inner metallic yarns 44 act to provide structure and rigidity to the gasket 10 and to promote the scrolled sealing portions 20, 22 to remain in their scrolled configuration.

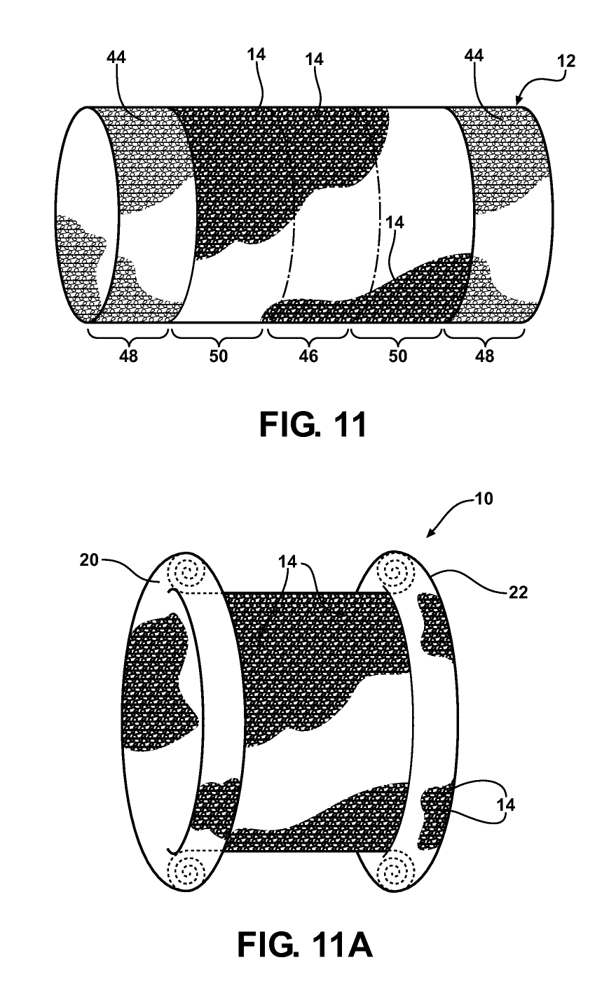

As shown in FIG. 11, the tubular body 12 can be constructed having a central region 46 knit with non-metallic high heat resistant yarns 14 in a ribbed pattern, such as a 2×2 pattern, for example. The central region 46, being knit with a ribbed pattern, provides added elasticity to the body 12. The body 12 also has a pair of end regions 48 knit with metallic yarns 44, such as in a jersey knit pattern, for example. Further, the body 12 is constructed with a pair of intermediate regions 50 between the end regions 48 and the central region 46. The intermediate regions 50 are knit with non-metallic heat resistant yarns 14, such as in a jersey knit pattern, for example. Accordingly, the body 12 has discrete sections of metallic yarns and non-metallic yarns along the length of the body 12. Upon knitting the full length of the body 12, the end regions 48 can be rolled a predetermined distance until the intermediate regions 50 become at least partially rolled to form a radially outwardly facing outer surface of the rolled sealing portions 20, 22 on opposite sides of the central region 46. Accordingly, as shown in FIG. 11A, as in the embodiment discussed above in relation to FIG. 10, the non-metallic yarns 14 are exposed to face radially outwardly from the body 12, thereby providing an outer surface suitable for establishing a reliable, air-tight seal, while the covered inner metallic yarns 44 act to provide structure and rigidity to the gasket 10 and to promote the rolled sealing portions 20, 22 to remain in their rolled configuration.

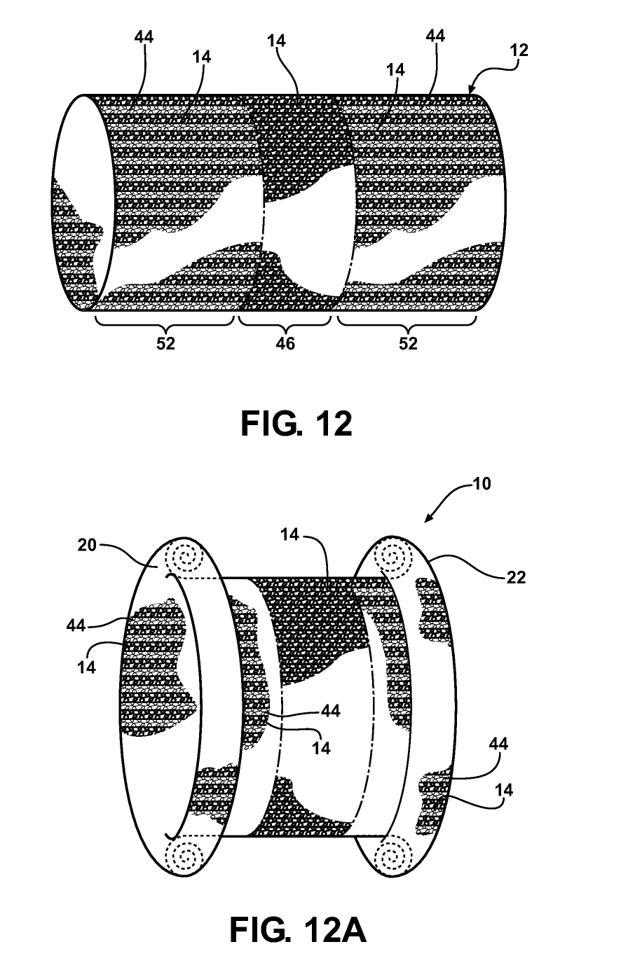

As shown in FIG. 12, the tubular body 12 can also be constructed having a central region 46, as discussed above in relation to FIG. 11, and a pair of end regions 52 knit with both non-metallic yarns 14 and metallic yarns 44, such as in a double jersey knit pattern, for example. Then, upon knitting the full length of the body 12, as shown in FIG. 12A, the outer regions 52 are rolled to form axially opposite pairs of rolled sealing portions 20, 22 on opposite sides of the central region 46. Unlike the embodiment of FIG. 11, however, the outer surface of the rolled portions 20, 22 have both metallic and non-metallic yarns 14, 44.

Many modifications and variations of the present invention are possible in light of the above teachings. For example, wherein non-metallic and metallic yarns are used in the construction of the gasket body, the respective yarns could be served with one another. It is, therefore, to be understood that within the scope of the appended claims, the invention may be practiced otherwise than as specifically described and illustrated.

What is claimed is:

1. A high temperature textile gasket for establishing a seal between mating members, comprising:
a knit, seamless tubular body having a plurality of non-metallic, heat-resistant yarns knit with one another with a plurality of knit stitches, said body extending along a longitudinal axis between opposite ends with at least one of said ends being rolled toward the other of said ends and forming a circumferentially extending rolled portion of a predetermined diameter for receipt between the mating members.

2. The textile gasket of claim 1 wherein said tubular body includes a plurality of metallic yarns knit with said non-metallic yarns.

3. The textile gasket of claim 2 wherein a first portion of said body extending axially inwardly from one of said ends is formed entirely of said non-metallic yarns and a second portion of said body extending axially inwardly from the other of said ends is formed entirely of said metallic yarns.

4. The textile gasket of claim 3 wherein said first portion is reverse folded inwardly of said second portion, said non-metallic yarns of said at least one end facing radially outwardly from said body.

5. The textile gasket of claim 1 wherein both of said ends are rolled toward one another forming a pair of circumferentially extending rolled portions of a predetermined diameter for receipt between the mating members.

6. The textile gasket of claim 5 wherein one of said rolled portions has a greater inner diameter than the other of said rolled portions.

7. The textile gasket of claim 5 wherein an unrolled bridge section interconnects said rolled portions.

8. The textile gasket of claim 5 wherein one of said rolled portions is formed from said non-metallic yarns and the other of said rolled portions is formed from metallic yarns.

9. The textile gasket of claim 1 wherein said tubular body includes a plurality of metallic yarns knit with said non-metallic yarns, said metallic yarns and said non-metallic yarns alternating with one another along the length of said body to form discrete sections of said metallic yarns and said non-metallic yarns.

10. A method of constructing a textile gasket, comprising:
providing a plurality of non-metallic yarns;
knitting said non-metallic yarns with one another into a seamless tubular body having a length extending between opposite ends; and
rolling at least one of said ends toward the other end to form a first circumferential scrolled sealing portion of a predetermined diameter for receipt between the mating members.

11. The method of claim 10 further including knitting at least one metallic yarn with the non-metallic yarns to provide the tubular body with both non-metallic yarns and metallic yarns.

12. The method of claim 10 further including knitting the metallic yarns and the non-metallic yarns to form discrete tubular sections of the metallic yarns and said non-metallic yarns.

13. The method of claim 12 further including knitting the non-metallic yarns to extend inwardly from one of the ends of the tubular body and knitting the metallic yarns to extend inwardly from the other of the ends of the tubular body.

14. The method of claim 13 further including rolling both of the ends toward one another and forming a rolled portion from the non-metallic yarns and a rolled portion from the metallic yarns.

15. The method of claim 13 further including reverse folding the non-metallic yarns inwardly of the metallic yarns and rolling the ends to bring the non-metallic yarns into a radially outwardly facing orientation.

16. The method of claim 11 further including knitting the non-metallic and metallic yarns with one another using a double jersey knit stitch.

17. The method of claim 11 further including laying the metallic yarns into the non-metallic yarns.

18. The method of claim 10 further including rolling the other of said ends to form a second circumferential rolled sealing portion of a predetermined diameter for receipt between the mating members.

19. The method of claim 18 further including rolling one of the ends a greater distance than the other of the ends and forming one of the rolled portions having a greater inner diameter than the other of the rolled portions.

20. The method of claim 10 further including performing the knitting using a flat bed weft knitting process.
